(19) United States
(12) Patent Application Publication
(10) Pub. No.: US 2021/0293653 A1
(43) Pub. Date: Sep. 23, 2021

(54) METHOD FOR DETERMINING LIQUID CONSUMPTIONS OF A PLURALITY LIQUID CONSUMERS

(71) Applicant: GROHE AG, Hemer (DE)

(72) Inventors: Moukarram KABBASH, Dortmund (DE); Timo FISCHER, Hemer (DE)

(73) Assignee: GROHE AG, Hemer (DE)

(21) Appl. No.: 17/197,171

(22) Filed: Mar. 10, 2021

(30) Foreign Application Priority Data
Mar. 10, 2020 (DE) 102020106484.5

(51) Int. Cl. G01M 3/28; E03B 7/04; G06N 20/00

(52) U.S. Cl. CPC G01M 3/2815; G06N 20/00; E03B 7/04

(57) ABSTRACT

The invention relates to a method for determining liquid consumptions of a plurality of liquid consumers (1, 2, 3), comprising at least the following steps:
a) Detecting at least one liquid consumption process (4) on a liquid line (5), by means of which a liquid can be supplied to the plurality of liquid consumers (1, 2, 3);
b) Recording at least one piece of information about the at least one liquid consumption process (4),
c) Assigning the at least one liquid consumption process (4) to at least one liquid consumer class by means of a machine-learned algorithm, which determines the at least one liquid consumer class as a function of the at least one piece of information recorded and under consideration of information about previously detected liquid consumption processes (4).

The present invention relates to a method for determining liquid consumptions of a plurality of liquid consumers. The method serves in particular to identify liquid consumers having a high liquid consumption. In particular, the method can be used for self-improving detection of plumbing products by means of artificial intelligence.

In supply units, such as buildings, apartments or hotel rooms, a large number of liquid consumers are regularly installed, for example such as dishwashers, washing machines and or flushing toilets or in the form of faucets for dispensing liquid in washbasins, sinks, showers and/or bathtubs. These liquid consumers are regularly connected by means of a liquid line to a public liquid supply network, by way of which the liquid, in particular water, is supplied to the liquid consumers. To bill the quantity of the liquid consumed in a supply unit, consumption meters are known which are arranged in the liquid line in the region of a liquid main connection of the relevant supply unit. Only overall consumption of the liquid of all liquid consumers in the relevant supply unit can be measured using these consumption meters, however, but not the consumption of the liquid by one or more specific liquid consumers. Therefore, a user of the liquid consumer cannot monitor which liquid consumers cause a particularly high amount of liquid consumption. Due to this, it is therefore not possible to optimize or reduce the consumption of liquid in a targeted manner.

It is therefore the task of the invention to, at least partially, solve the problems described with reference to the prior art and, in particular, to specify a method for determining liquid consumptions of a plurality of liquid consumers with which the liquid consumption of specific liquid consumers of a supply unit can be determined. Moreover, in particular, a determination of liquid consumption even in the case of complex liquid consumption processes is to be enabled, in which a plurality of different liquid consumers consume simultaneously or at overlapping times.

These tasks are solved with a method according to the features of the independent patent claim. Further advantageous embodiments of the invention are specified in the dependent patent claims. It should be noted that the features listed individually in the dependent patent claims can be combined with one another in any technologically meaningful manner and define further embodiments of the invention. In addition, the features stated in the patent claims are further specified and explained in the description, wherein further preferred embodiments of the invention are presented.

In this case, a method contributes to determining liquid consumptions of a plurality of liquid consumers which comprises at least the following steps:
a) Detecting at least one liquid consumption process on a liquid line, by means of which a liquid can be supplied to the plurality of liquid consumers;
b) Recording at least one piece of information about the at least one liquid consumption process,
c) Assigning the at least one liquid consumption process to at least one liquid consumer class by means of a machine-learned algorithm, which determines the at least one liquid consumer class as a function of the at least one piece of information recorded and under consideration of information about previously detected liquid consumption processes.

The steps a) to c) may be performed in order to carry out the method, for example, at least once in the specified sequence. Furthermore, the steps a) to c) may be repeated (multiple times) or the method may be repeated (in the manner of a loop), beginning with step a). At least parts of the steps a) to c), in particular steps a) and b), may be performed at least partially in parallel or simultaneously. The method may be carried out using an algorithm which was trained with a training method described here as well.

The majority of liquid consumers is arranged in particular in a (single) supply unit, such as a building, an apartment or a hotel room. A liquid, in particular water, can be supplied via a liquid line, which connects the liquid consumers in particular with a public liquid supply network. The liquid consumers may be in particular faucets for dispensing liquid in washbasins, sinks, showers and/or bathtubs and/or dishwashers, washing machine and or flushing toilets.

Each liquid consumer triggers a liquid consumption when dispensing liquid or in the case of its use. The relevant liquid consumption processes begin with the dispensing of liquid by a liquid consumer or the use of a liquid consumer, and end with the end of the dispensing of the liquid by the liquid consumer or the end of the use of the liquid consumer. The liquid consumption processes may thus span a certain timeframe. The liquid consumption processes are detected in step a) on the liquid line. For this purpose, a measuring apparatus may be arranged in the liquid line. The measuring apparatus is arranged upstream of the liquid consumers in the liquid line in the direction of flow of the liquid through the liquid line in such a way that all liquid consumption processes of the liquid consumers can be detected by the measuring apparatus. The beginning of the relevant liquid consumption processes can be detected by the measuring apparatus in particular through an increase in the flow velocity or an increase in a volumetric flow of the liquid through the liquid line. The end of the relevant liquid consumption processes can be detected accordingly by the measuring apparatus in particular through a reduction in the flow velocity or a reduction in a volumetric flow of the liquid through the liquid line. For this purpose, the measuring apparatus may comprise, for example, a flow sensor by means of which the flow rate of the liquid through the liquid can be determined. Furthermore, the volumetric flow of the liquid can be calculated by way of the flow velocity of the liquid and a (known) cross-section of the liquid line, for example in m³/s (cubic meters per second) or l/min (liters per minute). Moreover, complex liquid consumption processes may occur in which a plurality of (different) liquid consumers consume liquid or are used simultaneously or at overlapping times. In this way, the use of a washing machine may overlap in time with a use of a faucet. Correspondingly complex liquid consumption processes are conceivable in very many possible combinations, such that an assignment of the respective (individual)liquid consumption processes involved in the complex liquid consumption process to the liquid consumer class usually requires a complex analysis. For this purpose, large quantities of data must be considered, since due to the large number of possible combinations, a correspondingly large number of patterns of consumption processes may exist. For the analysis of corresponding, and possible unforeseen patterns, an analysis by means of the machine-learned algorithm has proven to be particularly advantageous, in particular since this can also handle new or as yet unknown patterns of complex consumption processes or learn how to handle them. In particular, new patterns can be recognized in an advantageous manner using artificial intelligence.

In step b), the recording of at least one piece of information about the at least one liquid consumption process takes place. The liquid consumption during the individual liquid consumption processes and/or during a complex liquid consumption process may, for example, be determined. The liquid consumption may, for example, be calculated by way of the volumetric flow of the liquid during the liquid consumption process and the timespan or the duration of the liquid consumption process. By determining the liquid consumption, it is thus known how many liters of liquid were consumed during the liquid consumption process. The determination of the liquid consumption can take place in particular using a measuring apparatus.

At least one parameter of the liquid consumption process may be determined as an (possibly additional) piece of information by way of a liquid consumption process. The at least one parameter is in particular at least a state variable which can serve to identify the liquid consumer triggering the consumption process or a type of the liquid consumer triggering the liquid consumption process. The determination of the at least one parameter can take place, for example, with a data processing system, for example in the manner of a control. The algorithm may be stored, for example, in the data processing system or the system may access this. The data processing system may be formed in the measuring apparatus or outside the measuring apparatus. Furthermore, the data processing system may be arranged in the measuring apparatus or outside the measuring apparatus. Additionally, the data processing system may be formed, for example, outside a supply unit on a (cloud) server. The data processing system is connected to the measuring apparatus in particular by way of a data connection, for example in the manner of a radio connection, wired connection and/or internet connection. The determination of the at least one parameter may take place in particular by an analysis of the measured values generated by the measuring apparatus. In particular, for this purpose, the measured values and/or the curves of the measured values during a liquid consumption process, for example their height, increase, duration and/or statistical characteristic values, such averages or quantiles, may be analyzed. In the analysis of the measured values generated by the measuring apparatus, in particular at least one parameter is determined which is characteristic for the respective liquid consumers triggering the liquid consumption processes, so that the liquid consumers triggering the liquid consumption process may (at least partially) be identified by way of at least one parameter of the liquid consumption process. During analysis, the “fingerprint” of the various fluid consumers in the measured values which these generate during the liquid consumption processes is sought after. The determination of the at least one parameter may thus also comprise statistical methods.

In step c), an assignment of the at least one liquid consumption process to at least one liquid consumption class by means of a machine-learned algorithm, which determines the at least one liquid consumer class as a function of the at least one piece of information recorded and under consideration of information about previously detected liquid consumption processes takes place. In this context, a complex liquid consumption process can for example be assigned to a plurality of liquid consumer classes, wherein a subdivision of the complex liquid consumption process or its recorded liquid consumption into the plurality of liquid consumer classes may take place. Furthermore, a plurality of (individual) liquid consumption processes may be assigned to a (certain) liquid consumer class.

Through the use of the machine-learned algorithm, a large amount of content can be taken into consideration in an advantageous manner, which may also take into consideration historical information about previously detected liquid consumption processes or previously learned patterns of possibly complex liquid consumption processes. The information about previously detected liquid consumption processes or previously learned patterns may have been learned in particular during an (initial) training phase. The information learned in particular during the (initial) training phase may be represented for example by corresponding configurations (adaptations) and/or links of elements of the algorithm. The elements may be for example model parameters of the algorithm, such as weights, functions, thresholds or the like. The algorithm may be realized by an (artificial intelligence of KI-) model and/or in a (KI-)model. The algorithm may further comprise a plurality of parts or partial algorithms, which may cooperate with one another on one level next to one another and/or on a plurality of levels above one another and/or in a plurality of time steps after one another.

For example, the algorithm may be set up such that it maps a set of input data to at least one output or one set of output data. The at least one piece of information recorded (through sensory means) about the at least one liquid consumption process usually forms an input or input data of the algorithm. The assignment to the at least one liquid consumer class or a specific liquid consumer class (possibly in combination with one or more assigned liquid consumptions) usually forms an output or output data of the algorithm, sets of data may be provided for example in the form of vectors, such as for example at least one input vector and at least one output vector.

The algorithm may for example be formed in the manner of a so-called machine learning model. For example, the algorithm may be formed by means of at least one artificial neural network. The network usually contains elements or model parameters, by means of which the input data may be mapped to the output data. Corresponding elements or model parameters may comprise for example, nodes, weights, links, thresholds or the like. During a training of the algorithm, at least individual or a plurality of the elements of model parameters may be adapted. In particular, in addition to an (initial) training of the algorithm, it may also be provided that this can be improved during continuous (further) operation. In this context, the algorithm may be executed for example in a self-learning manner. In particular, training phases can be performed during continuous operation (for example at specific times or continuously). For example, during continuous operation, comparative investigations to determine the possibly complex liquid consumption processes may be performed, in order to validate and/or (further) improve the classification performed by the algorithm. Furthermore, the algorithm may (possibly constantly) be improved, in that it (constantly or at least even after an initial training) is trained with new training data. This new training data may for example be generated by new recordings and/or procured in a targeted manner for such water events which (previously) could be classified only with a small amount of precision.

For the assignment, the liquid consumption of the individual liquid consumption processes of a liquid consumer class may for example be assigned as a function of the at least one parameter. The liquid consumer class is formed in particular by a (single) liquid consumer of the supply unit or by a plurality of liquid consumers in particular of the same or a similar type. In other words, each liquid consumer of the supply unit may form its own liquid consumer class or a plurality of in particular the same or similar liquid consumers of the supply unit may form a common liquid consumer class. For example, all faucets on washbasins and sinks, all flushing toilets, all faucets in showers and/or all faucets on bathtubs may each form a liquid consumer class. The plurality of liquid consumers of a supply unit in this case form in particular a plurality of (different) liquid consumer classes. In step c), a classification of the individual liquid consumption processes may take place using the at least one parameter and by way of the classification an assignment of the liquid consumption of the respective liquid consumption processes to a specific liquid consumer class may take place. In particular, the liquid consumptions assigned to a specific liquid consumer class are added to together. Step c) may preferably also be performed using the data processing system. Furthermore, the liquid consumptions of the individual liquid consumer classes or liquid consumers may be displayed to a user on the measuring apparatus and/or using the data processing system. For this purpose, the measuring apparatus and/or the data processing system may comprise a display and/or a user interface which the user may access for example by means of a computer or smartphone.

According to an advantageous embodiment, it is proposed that the at least one piece of information describes a volumetric flow or flow duration of the liquid flowing through the liquid line. In this context, a volumetric flow and/or a flow duration of the liquid through the liquid line may be determined as information or parameter. The flow duration is in particular the timespan or the duration of the liquid consumption process. The volumetric flow and the flow duration of the liquid during a liquid consumption process may be characteristic for specific kinds of liquid consumers. For example, a volumetric flow of 3 to 12 l/min and a flow duration of 10 to 50 seconds are typical for a faucet on a washbasin, a volumetric flow of 5 to 12 l/min typical for a flushing toilet, a volumetric flow of 6 to 12 l/min and a flow duration of 180 to 600 seconds is typical for a faucet in a shower, as well as a volumetric flow of 10 to 25 l/min and a flow duration of 480 to 1200 seconds typical for a faucet on a bathtub.

According to an advantageous embodiment, it is proposed that the at least one piece of information describes a liquid pressure of the liquid flowing through the liquid line. In this context, a liquid pressure of the liquid flowing through the liquid line may be determined as information or parameter. For this purpose, the measuring apparatus can be provided with a pressure sensor, for example. The liquid pressure during a liquid consumption process may be characteristic for specific kinds of liquid consumers. The determination and/or use of the liquid pressure may take place for example as further parameter if the determination of the volumetric flow and/or the flow duration of the liquid is not sufficient for unambiguous identification of the liquid consumer class or the liquid consumers.

According to a further advantageous embodiment, it is proposed that the at least one piece of information describes an increase in a liquid pressure of the liquid flowing through the liquid line. In this context, an increase in a liquid pressure of the liquid through the liquid line may be determined as information or parameter. The determination of the increase in the liquid pressure can take place for example using the measuring apparatus and/or the data processing system. In particular, the increase or the fall in the liquid pressure at the beginning and/or at the end of a liquid consumption process may be characteristic for a liquid consumer class or a liquid consumer. The determination and/or use of the increase in the liquid pressure may take place for example as further parameter if the determination of the volumetric flow, the flow duration of the liquid and/or the liquid pressure is not sufficient for unambiguous identification of the liquid consumer class or the liquid consumers.

According to a further advantageous embodiment, it is proposed that the at least one piece of information describes an increase in a liquid pressure of the liquid flowing through the liquid line. In this context, a fluctuation in a liquid pressure of the liquid flowing through the liquid line may be determined as information or parameter. The pressure fluctuations during a liquid consumption process may be characteristic for specific liquid consumers. The determination and/or use of the fluctuations in the liquid pressure may take place for example as further parameter if the determination of the volumetric flow, the flow duration, the liquid pressure and/or the increase in liquid pressure is not sufficient for unambiguous identification of the liquid consumer class or the liquid consumers.

Furthermore, a day of the week can be specified as information or parameter. The day of the week may be used as information or parameter to identify a liquid consumer class or a liquid consumer, because certain liquid consumer classes or liquid consumers are used on certain days of the week with greater likelihood. In this way, for example, from Mondays to Fridays, faucets are used more frequently in showers and from Saturdays to Sundays, faucets are used more frequently on bathtubs. Furthermore, the liquid consumption is higher overall on Saturdays and Sundays. The day of the week may therefore be used in particular for statistically evaluating a likelihood of use of a specific liquid consumer and thus of a specific liquid consumer class.

Furthermore, a time of day can be specified as information or parameter. For example, from Mondays to Fridays, flushing toilets, faucets on washbasins and/or faucets in shower are used more frequently in the morning. Furthermore, from Mondays to Fridays, flushing toilets and faucets on washbasins are frequently used at shorter time intervals. Moreover, from Mondays to Fridays, faucets are used more frequently in the evening on showers, flushing toilets are used two to three times, and/or faucets are used three to four times. The time of day may also therefore be used in particular for statistically evaluating a likelihood of use of a specific liquid consumer and thus of a specific liquid consumer class.

Furthermore, at least one piece of information and/or the parameter may be determined by a liquid consumer. The liquid consumer may identify itself by the information or the parameter in particular in the data processing system. For this purpose, the liquid consumer may also be connected to the data processing system by way of a data connection. The liquid consumption of the liquid consumption process caused by the liquid consumer may be assigned in step d) to the liquid consumer class to which the liquid consumer belongs.

According to a further advantageous embodiment, it is proposed that the algorithm additionally outputs, in addition to the assignment, a piece of information on the precision of the assignment. The algorithm may in particular be applied to a large number of water events which do not yet have a classification. The algorithm may in particular not determine or perform the classification, but rather preferably output a percentage which describes the precision of this classification.

According to a further aspect, a training method for a machine-learnable algorithm is proposed which can assign the at least one liquid consumption process to at least one liquid consumer class, in that it determines the at least one liquid consumption class as a function of the at least one piece of information about the at least one liquid consumption process, comprising at least the following steps:
i) Reading in training input data for the algorithm, which comprises information about a large number of liquid consumption processes,
ii) Reading in training output data, which comprise the liquid consumer classes on the read-in training input data,
iii) Adapting elements of the algorithm, in order to map the read-in training input data as precisely as possible to the read-in training output data.

The steps i) to iii) may be performed in order to carry out the method, for example, at least once in the specified sequence. Furthermore, the steps i) to iii) may be repeated (multiple times) or the method may be repeated (in the manner of a loop), beginning with step i). At least parts of the steps i) to ii), may be performed at least partially in parallel or simultaneously. The method may be performed for machine learning of an algorithm also described here.

The training data may be procured for example in that the behavior pattern of different individual in different life situations is recorded and analyzed using different plumbing devices. This data (training input data) may be cleansed and stored with the respective classification (training output data). Statistical analyses may be used for checking the quality of the training data.

According to a further aspect of the invention, a data processing system is proposed which comprises a processor which is configured such that it executes to method according to the invention. The processor (controller) may for example access the storage medium described in the following to perform a method described here and/or execute the computer program. The storage medium and/or the computer program may also be a component of the system or be connected with these by way of a signal.

According to a further aspect, a computer program for performing a method described here is also proposed. This relates in other words in particular to a computer program (product), comprising commands which during execution of the program by a computer cause this to execute a method described here.

According to a further aspect, a machine-readable storage medium is also proposed on which the computer program is stored. Regularly, the machine-readable storage medium in a computer-readable data carrier.

The details, features and advantageous embodiments discussed in connection with the method for determining liquid consumption may also occur accordingly in the training method introduced here, the system, the computer program and/or the storage medium and vice-versa. To this extent, reference is made full to the remarks made there on the specific characterization of the features.

The invention and the technical environment are explained in more detail below with reference to the figures. It should be noted that the figures show particularly preferred embodiment variants of the invention, but is not limited thereto. In this case, identical components are given the same reference signs in the figures. Shown as examples and diagrams:

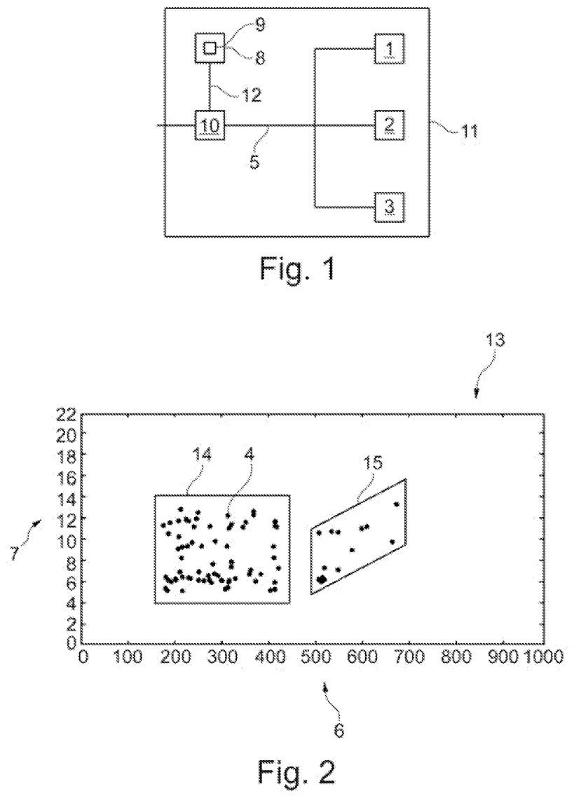

FIG. 1: an apparatus arranged on a liquid line;

FIG. 2: a first diagram with liquid consumption processes;

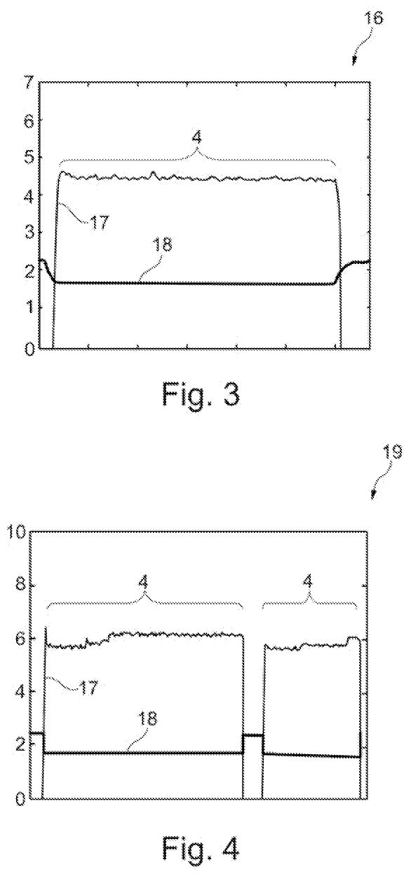

FIG. 3: a second diagram with liquid consumption processes; and

FIG. 4: a third diagram with liquid consumption processes.

FIG. 1 shows a measuring apparatus 10, which is arranged on a liquid line 5. With the liquid line 5, a liquid can be conducted from a liquid source (not shown) to a first liquid consumer 1, a second liquid consumer 2, and a third liquid consumer 3. The liquid consumers 1, 2, 3 are arranged in the same supply unit 11 and each form a liquid consumer class. By means of the measuring apparatus 10 (according to step a), liquid consumption processes 4 shown in FIG. 2 can be detected which are triggered by a use of the liquid consumer 1, 2, 3. Moreover, a liquid consumption may be determined during the individual liquid consumption processes by the measuring apparatus 10. The liquid consumption processes of the first liquid consumer 1, second liquid consumer 2 and third liquid consumer 3 comprise characteristic parameters 6, 7 (cf. FIG. 2) for the respective liquid consumer 1, 2, 3. These parameters 6, 7 may also be determined using a measuring apparatus 10. The measuring apparatus 10 is connected by way of a data connection 12 to a data processing system 8, which comprises a processor 9. By way of the data connection 12, the liquid consumptions of the individual consumption processes and the parameters 6, 7 of the individual consumption processes can be transferred by the measuring apparatus 10 to the data processing system 8. The data processing system 8 can evaluate or analyze the parameters 6, 7 of the liquid consumption processes and thereby establish by which liquid consumer 1, 2, 3 or by which liquid consumer class the respective liquid consumption process 4 was triggered. The liquid consumptions of the individual liquid consumption processes 4 may thus be assigned to the individual liquid consumers 1, 2, 3 or the respective liquid consumer classes by the data processing system 8 using the parameters 6, 7. The totaled liquid consumptions of the individual consumers 1, 2, 3 or the individual liquid consumer classes may be retrieved by a user for example by way of a user interface.

The recorded parameters 6, 7 described here may represent an example of the (according to step b) at least one piece of information recorded about the at least one liquid consumption process (4). The described assignment of the at least one liquid consumption process 4 to at least one liquid consumer class takes place by means of a machine-learned algorithm, which determines the at least one liquid consumer class as a function of the at least one piece of information recorded and under consideration of information about previously detected liquid consumption processes 4. Through the use of the algorithm, comparatively large quantities of data may be processed and/or patterns recognized in an advantageous manner, which in particular also may contribute to the determinability of liquid consumptions in case of complex liquid consumption processes.

FIG. 2 shows a first diagram 13 with a large number of liquid consumption processes 4, which are illustrated in the first diagram 13 as points. The positions of the individual liquid consumption processes 4 are established in the first diagram 13 for each liquid consumption process 4 by the flow duration of the liquid in seconds as first parameter 6 (horizontal x-axis) and the volumetric flow of the liquid in liters per minute as second parameter 7 (vertical y-axis). The flow duration and the volumetric flow of the liquid flowing during the individual liquid consumption processes 4 through the liquid line 5 shown in FIG. 1 to the respective liquid consumers 1, 2, 3 may be determined using the measuring apparatus 10 shown in FIG. 1. Through the position of the individual liquid consumption processes 4 in the first diagram 13, the liquid consumptions of the respective liquid consumption processes 4 may be classified by the data processing system 8 shown in FIG. 1, which executes, by way of example, the algorithm described here, and may be assigned to a liquid consumer 1, 2, 3 or one of the liquid consumer classes. In this case, the data processing system 8 may assign for example all liquid consumptions of those liquid consumption processes 4 to the first liquid consumer 1 or a first liquid consumer class, which are located in the first diagram 13 in the first region 14. Furthermore, the data processing system 8 may assign for example all liquid consumers of those liquid consumption processes 4 to the first liquid consumer 2 or a second liquid consumer class, which are located in the first diagram 13 in the second region 15. The first region 14 comprises those regions of the first parameter 6 and second parameter 7 which are characteristic in a liquid consumption process 4 for the first liquid consumer 1. The second region 15 accordingly comprises those regions of the first parameter 6 and second parameter 7 which are characteristic in a liquid consumption process 4 for the second liquid consumer 2. The first diagram 13 may comprise further regions in accordance with the number of liquid consumers 1, 2, 3 or the number of liquid consumer classes, which for the sake of clarity are not shown in FIG. 2. Moreover, the data processing system 8 can be configured to independently define further regions or the regions 14, 15, when for example further liquid consumers are connected to the liquid line 5 illustrated in FIG. 1 or one of the liquid consumers 1, 2, 3 are replaced.

Furthermore, there are use cases in which an unambiguous assignment of the liquid consumption of a liquid consumption process 4 to one of the liquid consumers 1, 2, 3 is not possible, because the regions 14, 15 partially overlap, for example. In this case, the data processing system 8 can take into consideration further parameters or information about the liquid consumption processes 4 in the assignment or classification and/or refer back to previously learned patterns or contexts. Examples of this are illustrated in FIGS. 3 and 4.

FIG. 3 shows a second diagram 16 in which a first graph 17 illustrates a volumetric flow of the liquid and a second graph 18 illustrates a curve of a liquid pressure of the liquid flowing in the liquid line 5 during a first liquid consumption process 4 of the first liquid consumer 1. Moreover, FIG. 4 shows a third diagram 19 in which the first graph 17 illustrates the curve of the volumetric flow of the liquid and a second graph 18 illustrates a curve of a liquid pressure of the liquid flowing in the liquid line 5 during a second liquid consumption process 4 of the second liquid consumer 2 (shown on the left) and a third liquid consumption process 4 of the third liquid consumer 3 (shown on the right). In the second diagram 16 and the third diagram 19, the flow duration of the liquid is plotted in seconds on the horizontal x-axis, and the volumetric flow and the liquid pressure of the liquid are plotted on the vertical y-axis. The curve of the volumetric flow and the curve of the liquid pressure of the liquid in the liquid line 5 may also be determined using the measuring apparatus 10. It can be seen inter alia in the second diagram 16 and third diagram 19 that the increase or the fall in the liquid pressure deviate from one another at the beginning and/or at the end of the individual liquid consumption processes 4 of the liquid consumers 1, 2, 3 and that the fluctuations in the volumetric flow and/or the liquid pressure during the individual liquid consumption processes 4 of the liquid consumers 1, 2, 3 are different. These may therefore be used by the data processing system 8 as additional parameters or information to identify the liquid consumers 1, 2, 3 or to assign the liquid consumption of the individual liquid consumption processes 4 to the individual liquid consumers 1, 2, 3 or the respective liquid consumer classes. In this context, FIGS. 3 and 4 may also illustrate examples of patterns which may be learned during the training by the learnable or self-learning algorithm and may be used later for classification.

The liquid consumption of specific liquid consumer classes or specific liquid consumers of a supply unit can be determined separately by the present invention. A method for determining liquid consumptions of a plurality of liquid consumers with which the liquid consumption of specific liquid consumers of a supply unit can be determined can thus be specified. Moreover, in particular, a determination of liquid consumptions even in the case of complex liquid consumption processes is to be made possible, in which a plurality of different liquid consumers consume simultaneously or at overlapping times.

### REFERENCE NUMERALS

1 first liquid consumer

2 second liquid consumer

3 third liquid consumer

4 liquid consumption process

5 liquid line

6 first parameter

7 second parameter

8 data processing system

9 processor

10 measuring apparatus

11 supply unit

12 data connection

13 first diagram

14 first region

15 second region

16 second diagram

17 first graph

18 second graph

19 third diagram

1. Method for determining liquid consumptions of a plurality of liquid consumers (1, 2, 3), comprising at least the following steps:
a) Detecting at least one liquid consumption process (4) on a liquid line (5), by means of which a liquid can be supplied to the plurality of liquid consumers (1, 2, 3);
b) Recording at least one piece of information about the at least one liquid consumption process (4),
c) Assigning the at least one liquid consumption process (4) to at least one liquid consumer class by means of a machine-learned algorithm, which determines the at least one liquid consumer class as a function of the at least one piece of information recorded and under consideration of information about previously detected liquid consumption processes (4).

2. Method according to claim 1, wherein at least one piece of information describes a volumetric flow or flow duration of the liquid through the liquid line (5).

3. Method according to claim 1, wherein the at least one piece of information describes a liquid pressure of the liquid flowing in the liquid line (5).

4. Method according to claim 1, wherein the at least one piece of information describes an increase in the liquid pressure of the liquid flowing in the liquid line (5).

5. Method according to claim 1, wherein the at least one piece of information describes a fluctuation in the liquid pressure of the liquid flowing in the liquid line (5).

6. Method according to claim 1, wherein the algorithm outputs, in addition to the assignment, a piece of information on the precision of the assignment.

7. Training method for a machine-learnable algorithm which can assign the at least one liquid consumption process (4) to at least one liquid consumer class, in that it determines the at least one liquid consumer class as a function of the at least one piece of information about the at least one liquid consumption process (4), comprising the following steps:
i) Reading in training input data for the algorithm, which comprises information about a large number of liquid consumption processes (4),
ii) Reading in training output data, which comprise the liquid consumer classes on the read-in training input data,
iii) Adapting elements of the algorithm, in order to map the read-in training input data as precisely as possible to the read-in training output data.

8. Data processing system (8), comprising a processor (9) which is configured such that it executes a method according to claim 1.

9. Computer program for performing a method according to claim 1.

10. Machine-readable storage medium on which the computer program according to claim 9 is stored.
